(19) United States
(12) Patent Application Publication
(10) Pub. No.: US 2026/0301066 A1
(43) Pub. Date: Oct. 1, 2026

(54) Commercial Invention Of Buying And Selling All The Dates In Gregorian Calender As Digital Right Or Digital Asset

(71) Applicant: Burak Konuklar, Istanbul (TR)

(72) Inventor: Burak Konuklar, Istanbul (TR)

(21) Appl. No.: 19/089,603

(22) Filed: Mar. 25, 2025

(51) Int. Cl. G06Q 40/04

(52) U.S. Cl. CPC G06Q 40/04

(57) ABSTRACT

This commercial invention enables all the dates in Gregorian calender to gain ownership by turning them into digital right or digital asset. This idea aims to collectors and investors to own dates in Gregorian Calender by purchasing digital right on them or using blockchain technologies. And over time, the digital right or digital asset in question will gain value due to sociological, emotional or historical reasons that happened or will happen in the world. And in this way the digital rights or digital assets in question will be used commercially.

### FIELD OF THE INVENTION

This commercial invention offers innovation in the digital right, digital asset and blockchain-based NFT asset field.

### BACKGROUND OF THE INVENTION

By this commercial intellectual property mentioned in this patent, the world have a truly unique digital right or digital asset. If a painter turns his/her own work into NFT asset, a copy or similar version of that work can be produced. Or if a musician turns his/her own work into NFT asset, a copy or similar version of that work can be produced. But this commercial intellectual invention mentioned in this patent is unique because it is based on Gregorian calender. Every date is unique by its nature. And each day is available in 5 format.

This commercial intellectual property mentioned in this patent creates a new and unique area for collectors and investors because this invention turns all the dates in Gregorian calender into a digital right or digital asset and by the way, all the dates in Gregorian calender becomes buying-selling or investment item. The purpose of the commercial idea in question is to produce digital right or digital asset which gains value over time due to sociological, emotional or historical reasons that happened or will happen in the world. And thus this commercial intellectual property creates valuable assets for collectors or to enable investors to invest in the existing historical value(s) or possible historical values. In this way, both the seller and buyer will make a profit.

### DETAILED DESCRIPTION

This commercial intellectual invention mentioned in this patent can be evaluated in two ways. The first is as a digital right and the second is as a digital asset. Firstly, I will explain digital right side. After these, formats will be explained.

### A.) Digital Right

If a company or an organization wants to use the commercial intellectual invention mentioned in this patent, it can build a website or can use an existing website to manage buying-selling of dates in Gregorian calender. The buyer buys the dates which buyer chooses in one format or all format as desired. The dates which buyer buys and name of the buyer (if buyer gives the permission for showing his/her/its name), his/her/its name is also displayed on the website. In this way, the buyer which bought the date can show that the buyer has the date in every area where has internet. Or the buyer can assign the digital right to a (n) person/company/organization by choosing his/her/its email in list on website. Or other methods can be used by the licence holder to perform the assigning process.

### B.) Digital Asset

If a company or an organization wants to use this commercial invention in question, the company/organization can create its own NFT market or use one of the existing NFT markets to selling dates in Gregorian calender that have been turned into digital assets in a format or formats of the buyer's choice.

### C.) Formats

The dates in Gregorian calender are available in 5 format. Buyer can take one of them or all of them. These formats are as follows;

| | |
|---|---|
| Day/Month/Year | (15 Jan. 2000) |
| Month/Day/Year | (Jan. 15, 2000) |
| Year/Month/Day | (2000 Jan. 15) |
| Day/Month/Year | (15 Jan. 2000) |
| Month/Day/Year | (Jan. 15 2000) |

### Advantages of the Invention

If a painter turns his/her own work into NFT asset, a copy or similar version of that work can be produced. Or if a musician turns his/her own work into NFT asset, a copy or similar version of that work can be produced. But this commercial intellectual invention mentioned in this patent is quite unique because of the nature of the idea. This commercial intellectual invention also creates an unprecedented commercial area.

### CONCLUSION

This commercial intellectual invention mentioned in this patent is an idea has never been seen before, is quite innovative, and can be tempting both investors and collectors. It creates a unique area that has not been created yet for both collectors and investors. The digital rights and digital assets sold in this commercial intellectual invention mentioned in this patent may have gained or will gain value in over the time due to sociological, emotional or historical events. That is why it is a good way to invest for investors and good collection item for collectors.

1.-7. (canceled)

8. A method for buying a selling all the dates in Gregorian calendar as digital right or digital asset.

9. The method of claim 8, wherein the method comprises turning all past and future dates in the Gregorian calendar into a commercial item.

10. The method of claim 8, wherein each dates in the Gregorian calender are sold in 5 different formats.

11. The method of claim 10, wherein a buyer can buy one of the 5 formats by paying a fee.

12. The method of claim 11, wherein if a buyer wants to buy a date from Gregorian calendar in 5 different formats, buyer buys dates by paying separately for each format.

13. The method of claim 8, wherein the method includes all dates past and future in Gregorian calender, from the first year we know in Gregorian calender to forever.

14. The method of claim 8, wherein the value of each dates in Gregorian calender can gain or lose value due to sociological, emotional or historical reasons that happened or will happen in the world.
